(19) United States
(12) Patent Application Publication
(10) Pub. No.: US 2021/0267723 A1
(43) Pub. Date: Sep. 2, 2021

(54) DENTAL BRIDGE

(71) Applicant: Dean UltraThin Retainer, LLC, Fosston, MN (US)

(72) Inventor: Todd Sandwick, Fosston, MN (US)

(21) Appl. No.: 17/324,741

(22) Filed: May 19, 2021

Related U.S. Application Data
(63) Continuation-in-part of application No. 16/749,023, filed on Jan. 22, 2020.
(60) Provisional application No. 62/795,205, filed on Jan. 22, 2019.

(51) Int. Cl. A61C 7/14

(52) U.S. Cl. CPC A61C 7/146; A61C 7/145

(57) ABSTRACT

A dental bridge includes a mounting structure and at least one pontic or artificial tooth mounted to the mounting structure. The mounting structure includes a first bonding pad, a second bonding pad spaced from the first bonding pad, a rigid wire having a first end fixed to the first bonding pad and a second end fixed to the second bonding pad, and the pontic is secured to the rigid wire, for example via a pontic attachment structure on the rigid wire between the first bonding pad and the second bonding pad.

### FIELD

This technical disclosure relates to a dental/orthodontic appliance including, but not limited to, a fixed dental retainer or a dental bridge, and the use of one or more apertured bonding pads to fix the dental/orthodontic appliance to a patient's teeth.

### BACKGROUND

Orthodontic appliances have been in use for years in the orthodontic field for providing a variety of orthodontic benefits, for example retention after completion of an active phase of orthodontic treatment. Orthodontic appliances such as retainers can be removable or fixed, and can be used on the upper set of teeth and/or on the lower set of teeth. Examples of removable orthodontic retainers are Hawley retainers and the retainers described in U.S. Pat. No. 8,827,696. An example of a fixed retainer is described in U.S. Pat. No. 6,722,878. Another example of an appliance is a dental bridge that is used to bridge a gap created by one or more missing teeth by mounting one or more pontics (or false teeth) in the gap.

### SUMMARY

Improvements relating to dental/orthodontic appliances are described herein. The appliances can be any dental/orthodontic appliances that during use are bonded or fixed to the patient's teeth. In one non-limiting example, the appliance can be a dental bridge. In general, the dental bridge described herein has two primary components, in particular a mounting structure and at least one pontic mounted to the mounting structure. The mounting structure mounts the dental bridge in the patient's mouth near a gap created by one or missing teeth in the upper or lower set of teeth, with the at least one pontic filling the gap.

In one embodiment, a dental bridge described herein can include a first bonding pad, a second bonding pad spaced from the first bonding pad, and a rigid wire having a first end and a second end where the first end is fixed to the first bonding pad and the second end is fixed to the second bonding pad. A pontic (or artificial tooth) is secured to the rigid wire between the first bonding pad and the second bonding pad. For example, the pontic can be secured to a pontic mounting structure that is integrally formed with the rigid wire.

In another embodiment described herein, a method of fabricating a dental bridge can include integrally forming a first bonding pad, a second bonding pad, and a rigid wire from metal as a unitary one-piece construction using an additive manufacturing process, where the rigid wire has a first end and a second end, and the first end is fixed to the first bonding pad and the second end is fixed to the second bonding pad. A pontic is then attached to the rigid wire between the first bonding pad and the second bonding pad.

In the example case of a fixed orthodontic retainer, the language “fixed orthodontic retainer” used herein and in the claims refers to a retainer that is intended to be fixed in a patient's mouth for an extended period of time and is not intended to be temporarily removed by the patient and then reinserted by the patient like a traditional removable retainer like a Hawley retainer.

The fixed orthodontic retainers described herein can be, in use, fixed to the lower set of teeth and/or to the upper set of teeth of the patient. In addition, the fixed orthodontic retainers described herein can be, in use, fixed to the lingual surfaces of the patient's teeth (in which case the retainer may be referred to as a fixed lingual retainer) and/or to the facial (for example labial or buccal) surfaces of the patient's teeth (in which case the retainer may be referred to as a fixed facial retainer or fixed labial retainer or fixed buccal retainer). The fixed orthodontic retainers described herein can be designed and created for each individual patient and their teeth retention needs.

The orthodontic appliances described herein have at least one bonding pad that in use is bonded to the surface of one of the patient's teeth. In one embodiment, the orthodontic appliance can include two or more of the bonding pads described herein. In another embodiment, the orthodontic appliance can include three, four or more of the bonding pads. In one embodiment, the orthodontic appliance can have two bonding pads with the two bonding pads intended to be secured to respective tooth surfaces and a wire spanning across multiple teeth. In still another embodiment, the orthodontic appliance can have multiple bonding pads, one for each tooth that the appliance extends over.

Each bonding pad has a plurality of apertures that extend completely therethrough in a thickness direction of the bonding pad. The apertures permit use of a radiation curable adhesive, for example an ultra-violet (UV) light curable adhesive, to secure the bonding pads, and thus the orthodontic appliance, to the tooth surfaces. In particular, the apertures permit the UV curable adhesive to flow up and through the apertures as well as permit curing radiation, for example UV light, to reach the UV curable adhesive to cure the adhesive. In one embodiment, each bonding pad can include what may be referred to as a mesh portion that forms the plurality of apertures.

The bonding pads and the wire can be formed separately, and then later suitably secured to one another. Alternatively, the bonding pads and the wire can be integrally formed of a single material so as to form a single piece unitary construction. For example, the bonding pads and the wire can be integrally formed by a suitable additive manufacturing process. Additive manufacturing as used herein is intended to encompass any process where the bonding pads and the wire are created by adding layer-upon-layer of material to create the appliance. Additive manufacturing may also be referred to as 3D printing. In another embodiment, the appliances described herein can be created using a subtractive manufacturing process. However, in some embodiments, the appliances described herein can be created using other manufacturing techniques as well, for example by casting.

The bonding pads and the wire can be made of any material that one finds suitable for forming an orthodontic appliance. Examples of materials that can be used include, but are not limited to, metals including but not limited to pure metals such as gold, platinum, or titanium or metal alloys such as nickel titanium or a cobalt, chromium, molybdenum alloy; graphene; carbon; carbon fiber; plastic; and ceramic.

### DRAWINGS

FIGS. 1A and 1B are perspective views of a lower set of teeth with an orthodontic appliance, for example a fixed orthodontic retainer, described herein fixed thereto, with the retainer shown on the lingual surfaces of a subset of the lower teeth in FIG. 1A, and the retainer shown on the labial surfaces of the subset of the lower teeth in FIG. 1B.

FIGS. 2A and 2B are perspective views of an upper set of teeth with a fixed orthodontic retainer described herein fixed thereto, with the retainer shown on the lingual surfaces of a subset of the upper teeth in FIG. 2A, and the retainer shown on the labial surfaces of the subset of the upper teeth in FIG. 2B.

FIG. 3 is a close-up view of a portion of an orthodontic appliance such as the fixed orthodontic retainer including one of the bonding pads and a portion of the retainer wire integrally formed with the bonding pad.

FIG. 4 is a close-up view of a portion of another embodiment of the orthodontic appliance such as the fixed orthodontic retainer including one of the bonding pads and a portion of the retainer wire separate from the bonding pad.

FIG. 5 shows an embodiment of the fixed orthodontic retainer with two bonding pads.

FIGS. 6A and 6B are close-up views of additional embodiments of possible bonding pad shapes that can be used in the orthodontic appliances described herein.

FIG. 7 is a detailed side cross-sectional view showing UV curable adhesive extending upward through the apertures in one of the bonding pads.

FIG. 8 depicts an example of a dental bridge described herein in place on a set of teeth, with an artificial tooth (i.e. pontic) illustrated in dashed lines.

FIG. 9 depicts the mounting structure of the dental bridge.

FIG. 10 depicts the mounting structure from the opposite direction shown in FIGS. 8-9.

FIG. 11 depicts another embodiment of a mounting structure of the dental bridge with a different form of pontic attachment structure.

FIG. 12 depicts an example of an artificial tooth (i.e. pontic) that can be attached to the mounting structure of FIG. 11.

### DETAILED DESCRIPTION

The following is a description of orthodontic appliances made of metal or non-metallic materials such as graphene, carbon, carbon fiber, and techniques for forming the orthodontic appliances and securing the appliances to patient's teeth. The orthodontic appliances can be any orthodontic appliance used to perform an orthodontic treatment of a patient on the upper set of teeth and/or teeth in a lower set of teeth. In one embodiment, the orthodontic appliances will be described as being fixed orthodontic retainers used to retain teeth in an upper set of teeth or teeth in a lower set of teeth. In another embodiment, the appliance will be described as being a dental bridge. However, it is to be realized that the concepts described herein can be applied to other orthodontic appliances as well. Unless otherwise indicated in the claims to the contrary, the language “fixed orthodontic retainer” is to be construed as encompassing both an orthodontic retainer for a subset of teeth in the upper set of teeth and an orthodontic retainer for a subset of teeth in the lower set of teeth.

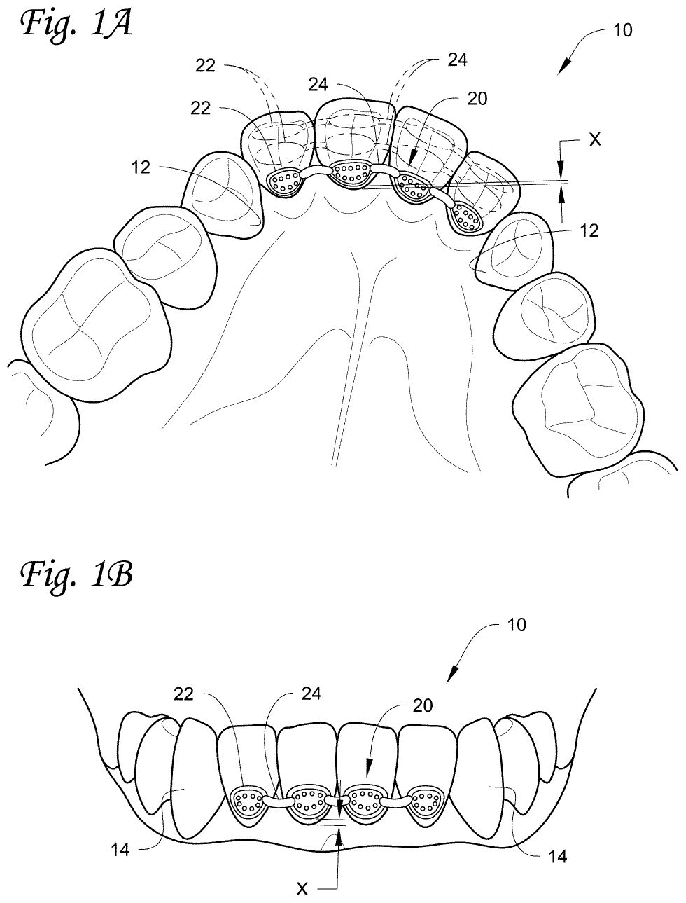

Referring initially to FIGS. 1A and 1B, a lower set of teeth 10 is illustrated. The teeth 10 can be generally described as including lingual surfaces 12 (i.e. surfaces that face generally inward toward the tongue and mouth) and facial surfaces 14 (i.e. surfaces that face generally outward). The facial surfaces 14 include labial surfaces on teeth that face toward the lips, and buccal surfaces on teeth that face toward the cheeks. In FIG. 1A, a fixed orthodontic retainer 20 described herein is illustrated as being fixed to the lingual surfaces 12 of a subset of teeth to be retained by the retainer 20. In particular, the retainer 20 is illustrated as including a number of bonding pads 22 (in this example four bonding pads 22) each of which is fixed to the lingual surface 12 of a corresponding tooth, and a rigid retainer wire 24 that extends between and is fixed to each of the bonding pads 22. In this embodiment, the retainer 20 may also be referred to as a fixed lingual retainer.

In an alternative embodiment that is illustrated in FIG. 1B, the bonding pads 22 can be fixed to the facial surfaces 14 of the subset of the teeth, and the retainer wire 24 extends between and is fixed to each of the bonding pads 22. In this example, FIG. 1B illustrates the retainer 20 as being fixed to the labial surfaces of the teeth, whereby the retainer 20 may also be referred to as a fixed labial retainer.

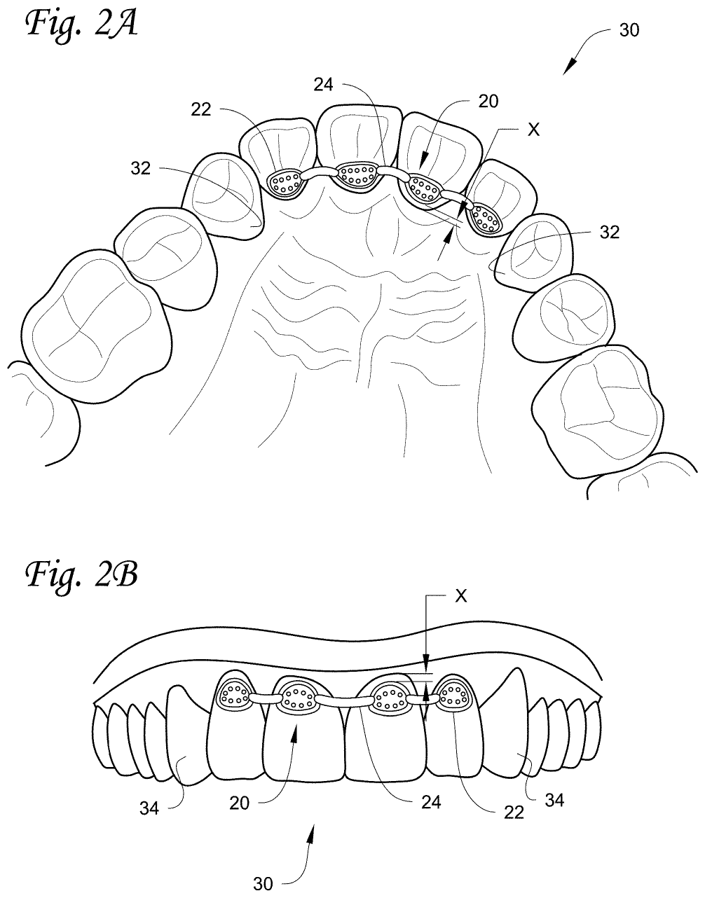

Referring to FIGS. 2A and 2B, an upper set of teeth 30 is illustrated. The teeth 30 can be generally described as including lingual surfaces 32 (i.e. surfaces that face generally inward toward the tongue and mouth) and facial surfaces 34 (i.e. surfaces that face generally outward). The facial surfaces 34 include labial surfaces on teeth that face toward the lips, and buccal surfaces on teeth that face toward the cheeks. In FIG. 2A, the fixed orthodontic retainer 20 described herein is illustrated as being fixed to the lingual surfaces 32 of a subset of teeth to be retained by the retainer 20. In particular, the bonding pads 22 are fixed to the lingual surface 32 of a corresponding tooth, and the rigid retainer wire 24 extends between and is fixed to each of the bonding pads 22. In this embodiment, the retainer 20 may also be referred to as a fixed lingual retainer.

In an alternative embodiment that is illustrated in FIG. 2B, the bonding pads 22 can be fixed to the facial surfaces 34 of the subset of the teeth, and the retainer wire 24 extends between and is fixed to each of the bonding pads 22. In this example, FIG. 2B illustrates the retainer 20 as being fixed to the labial surfaces of the teeth, whereby, the retainer 20 may also be referred to as a fixed labial retainer.

FIGS. 1A, 1B, 2A and 2B illustrate the retainer 20 as having one of the bonding pads 22, in this example four of the bonding pads 22, fixed to the surface of each tooth to be retained. However, other constructions are possible. For example, referring to FIG. 5, a partial set of teeth 40 (which can be a lower set of teeth or an upper set of teeth) is illustrated, and the retainer 20 is shown as having two of the bonding pads 22 secured to the lingual surfaces of what may be referred to as teeth numbers 1 and 4, and the rigid retainer wire 24 extends between and is fixed to the two bonding pads 22 and extends across teeth numbers 1 to 4. The retainer 20 in FIG. 5 could also be secured to the facial surfaces, for example the labial surfaces, of the teeth.

While FIGS. 1A, 1B, 2A, 2B and 5 illustrate the retainer 20 being used to retain four teeth, the retainer 20 can be configured to retain a smaller number of teeth including two or three teeth, or a larger number of teeth. If two teeth are being retained, one of the bonding pads 22 would be disposed on a surface of each tooth and the retainer wire 24 would extend between and be fixed to each one of the bonding pads 22. If three teeth are being retained, one of the bonding pads 22 can be disposed on each tooth or two of the bonding pads can be disposed on teeth 1 and 3 with the retainer wire extending between and fixed to each of the bonding pads 22 and extending over all three teeth. If more than four teeth are being retained, the bonding pads can be disposed on each tooth, or any number of the teeth as long as there is a bonding pad on the end teeth of the sequence of teeth being retained.

In another embodiment, the retainers described herein extend across a missing tooth whereby the retainer is used to maintain a gap between two teeth. For example, in the example depicted in FIG. 5, tooth 2 or tooth 3 could be missing and the retainer 20 could be used as depicted to maintain a gap between teeth 1 and 3 or between teeth 2 and 4.

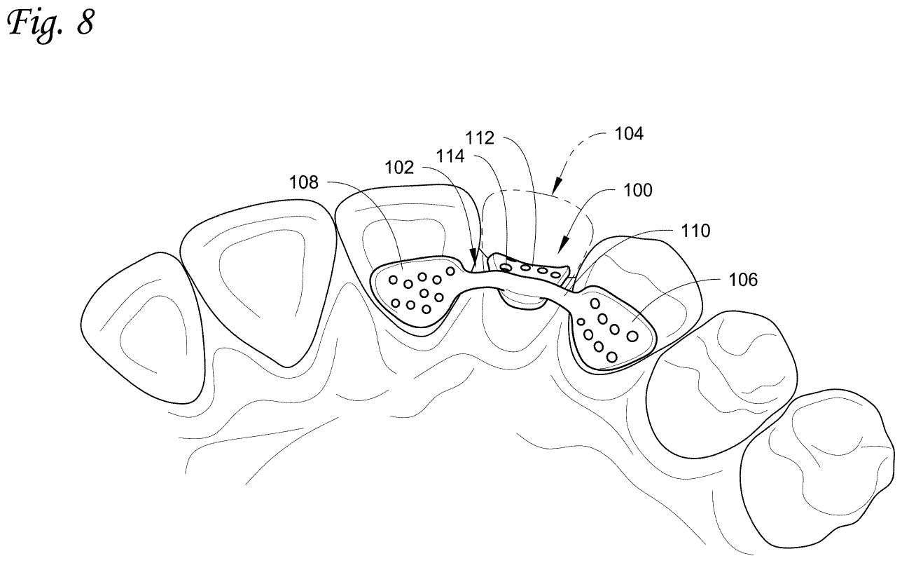

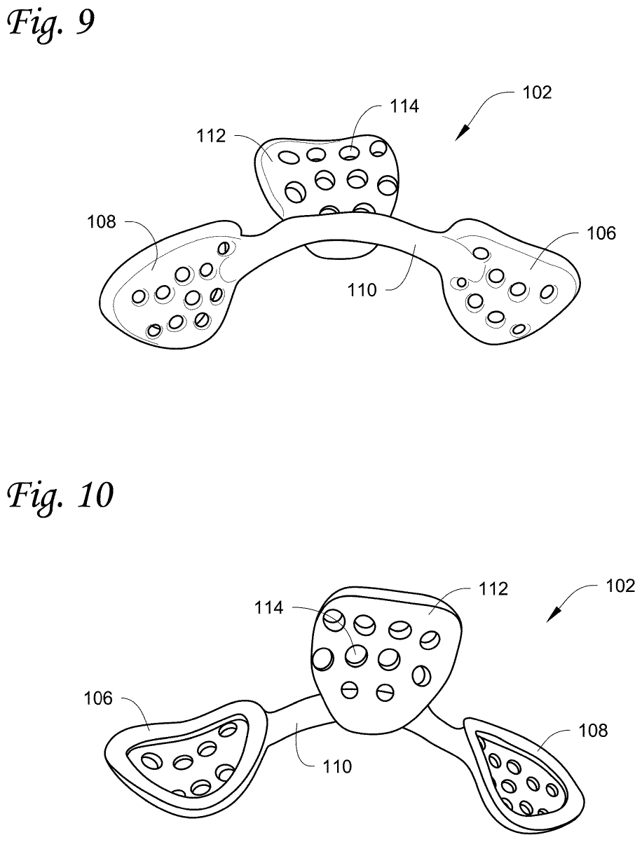

In still another embodiment described further below with respect to FIGS. 8-12, one or more artificial teeth can be secured to the retainers described herein, for example to the retainer wire and/or to one of the bonding pads, to form a dental bridge. The artificial tooth fills in a gap between teeth of the patient when the retainer is installed. For example, in the example depicted in FIG. 5, tooth 2 could be missing and the retainer 20 can include an artificial tooth, for example fixed to the retainer wire 24, that fills the gap between teeth 1 and 3 when the retainer 20 is installed.

The bonding pads 22 described herein can be secured to the tooth surfaces using any type of bonding technique known in dentistry. Examples of suitable bonding agents that can be used include, but are not limited to, radiation curable adhesives such as ultra-violet (UV) light curable adhesives, and non-UV light curable adhesives.

However, the construction of the bonding pads 22 of the retainer 20 are particularly useful with the use of radiation curable adhesives, such as UV light curable adhesives, to secure the bonding pads 22, and thus the orthodontic retainer 20, to the tooth surfaces (whether the lingual surfaces or the facial/labial surfaces). Conventional pads used on conventional fixed orthodontic retainers are solid in construction and are typically secured using a non-radiation curable adhesive or bonding material since the solid construction of the conventional bonding pad prevent UV light from reaching a UV curable adhesive located between the conventional bonding pad and the tooth surface. However, a UV curable adhesive provides a more secure and stronger attachment of the bonding pad 22 to the tooth surface. So the bonding pads 22 described herein are configured in a manner to permit UV light to reach the backside of the bonding pad and any adhesive located between the bonding pad 22 and the tooth surface, which therefore permits the use of UV curable adhesive.

In particular, as described in further detail below, each of the bonding pads 22 has a plurality of apertures therein. The apertures extend completely through the bonding pads 22 in a thickness direction of the bonding pad 22. When fixing the bonding pad 22 to the tooth surface, the apertures permit UV curable adhesive to flow up and through the apertures as well as permit UV light to reach the UV curable adhesive located between the bonding pad 22 and the tooth surface to cure the adhesive.

However, in some embodiments, bonding materials other than UV light curable adhesive could be used to secure the bonding pads to the tooth surfaces. For example, glass ionomer cement and glass ionomer hybrid materials, composite resins, 4-methacryloyloxyethy trimellitate anhydride (4-META), Panavia™, self-cure composites, light curable composites, and other bonding materials used in orthodontics or dentistry could be used.

In some embodiments, to enhance bonding of the bonding pads 22 to the tooth surfaces, some or all of the surfaces of the bonding pad can be etched to increase the bonding surface area of the bonding pads 22. For example, in one embodiment, the tooth facing surfaces of the bonding pads 22 can be etched, for example micro-etched, prior to application to the tooth surfaces to increase the bonding surface area of the bonding pads 22. In other embodiments, the tooth facing surfaces of the bonding pads 22 can be manufactured so as to be rough to simulate a resulting etched surface and increase the bonding surface area. In another embodiment, the entire surface of the bonding pad 22, including non-tooth facing surfaces, can be etched to increase the bonding surface area. Etching can be performed using any suitable etching technique, for example using a blasting powder or an acid.

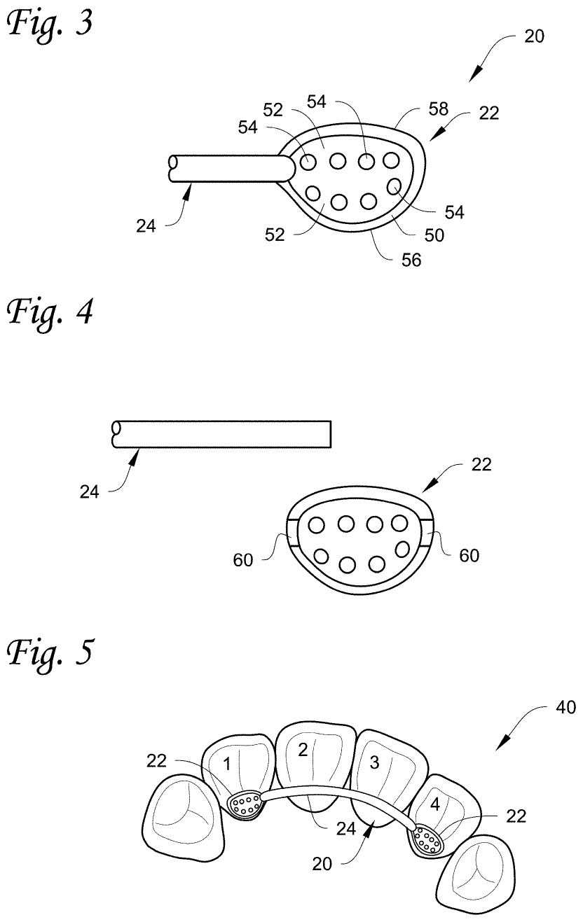

Referring to FIG. 3, a portion of the retainer 20 including one of the bonding pads 22 and a portion of the retainer wire 24 are illustrated. Only one of the bonding pads 22 is shown in FIG. 3, it being understood that the other bonding pad(s) 22 of the retainer 20 has an overall general construction that is similar to the illustrated bonding pad 22. In the illustrated example, the bonding pad 22 includes a perimeter frame 50 that defines the perimeter of the bonding pad 22. In this example, a material 52 is disposed within the perimeter frame 50, and a plurality of apertures 54 are formed in the material 52. The apertures 54 extend completely through the bonding pad 22 in the thickness direction of the bonding pad 22 so that the front or first side of the bonding pad 22 is in communication with the rear or second side of the bonding pad 22 via the apertures 54. The material 52 together with the apertures 54 form what may be referred to as a mesh or a mesh portion of the bonding pad 22.

The bonding pads 22 can be located at any position on the tooth surfaces dependent upon, for example, the needs of the patient. For example, the pads 22 can be located anywhere from against the gum line up to near the top of the tooth surfaces. In the illustrated example of FIGS. 1-5, the frame 50 has a bottom edge portion 56 that can be curved to generally match the curvature of the gum line (or curved to generally match the cingulum of the tooth to which the bonding pad is attached). The curved bottom edge portion 56 permits the bonding pads 22 and the retainer 20 itself to be located at a position that is lower on the tooth surfaces compared to traditional fixed orthodontic retainers. For example, the bonding pads 22 may be located on either the lingual surfaces or on the facial surfaces so that the bottom edge portion 56 may be a distance X of 0 to 10 mm from the gum line. FIGS. 1A, 1B, 2A and 2B illustrate the bonding pads in solid line on the tooth surfaces near, but slightly spaced from, the gum line. FIG. 1A also depicts (in broken lines) the bonding pads 22 located on the tooth surfaces at approximately the mid-height of the teeth (a similar position is possible in FIGS. 1B, 2A and 2B). FIG. 1A also depicts (in broken lines) the bonding pads 22 located on the tooth surfaces near the top of the tooth surfaces (a similar position is possible in FIGS. 1B, 2A, and 2B).

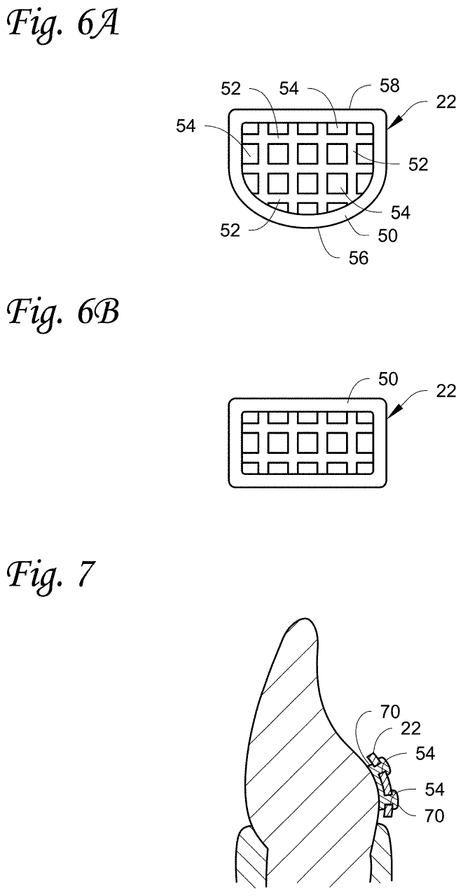

The frame 50 also has a top edge portion 58. FIG. 3 illustrates the top edge portion 58 as being curved somewhat like the bottom edge portion 56. However, other shapes of the frame 50, including the bottom edge portion 56 and the top edge portion 58, are possible. For example, FIG. 6A shows the bonding pad 22 with the frame 50 having the curved bottom edge portion 56 but the top edge portion 58 is straight or linear. FIG. 6B shows the bonding pad 22 with the frame 50 being substantially rectangular in shape. The frame 50 of the bonding pad 22 can have other symmetrical or non-symmetrical geometrical shapes including, but not limited to, substantially square, substantially triangular, substantially pentagonal, and the like.

Returning to FIGS. 1A, 1B, 2A, 2B, although the general shape of each of the bonding pads 22 is generally the same, the specific shape of each bonding pad 22 can vary from one another depending upon factors including, but not limited to, the shape of the tooth to which the bonding pad 22 is to be adhered. Some of the bonding pads 22 may be laterally wider (e.g. side-to-side) than others. Some of the bonding pads 22 may be vertically taller than others. Some of the bonding pads 22 may have a larger or smaller number of apertures 54 than others. Some of the bonding pads 22 may have a configuration like that shown in FIGS. 1A, 1B, 2A, 2B while other ones of the bonding pads 22 of the retainer may have a configuration like that shown in FIGS. 6A and/or 6B.

Returning to FIG. 3, the retainer wire 24 is a generally rigid structure that is fixed to the bonding pad 22. In the embodiment shown in FIG. 3, the bonding pad 22 (and the other non-illustrated bonding pad(s) 22) and the retainer wire 24 are integrally formed of a single material and form a single piece unitary construction with each other. For example, the bonding pads 22 and the retainer wire 24 can be integrally formed together by a suitable additive manufacturing process. Additive manufacturing as used herein is intended to encompass any process where the bonding pads 22 and the retainer wire 24 are created by adding layer-upon-layer of material to create the retainer 20. Additive manufacturing may also be referred to as 3D printing. In another embodiment, the retainer 20, including the bonding pads 22 and the retainer wire 24 can be integrally formed with one another using a subtractive manufacturing process. In another embodiment, the retainer 20, including the bonding pads 22 and the retainer wire 24, can be integrally formed with one another using other manufacturing techniques as well, for example by casting.

Examples of additive manufacturing processes that can be utilized to create the retainers describe herein include, but are not limited to, Selective Laser Melting (SLM), Selective Laser Sintering (SLS), Direct Metal Laser Sintering/Melting (DMLS or DMLM), Fused Deposition Modeling (FDM), Fused Filament Fabrication (FFF), Stereolithography (SLA), binder jetting, and Laminated Object Manufacturing (LOM).

Referring to FIG. 4, in another embodiment, the bonding pads 22 and the retainer wire 24 can be initially formed separately from one another, and then secured to one another to create the retainer 20. For example, the bonding pads 22 could be formed with one or more retaining features 60, such as slots, that permit the retainer wire 24 and the bonding pads 22 to be permanently secured to one another. For example, the retaining feature(s) 60 can permit the retainer wire 24 to snap fit connect to the bonding pads 22, or permit the retainer wire 24 and the bonding pad 22 to be welded or adhesively secured to one another. In the embodiment of FIG. 4, the bonding pads 22 and the retainer wire 24 can each be formed via an additive manufacturing process, such as 3D printing, by casting, or by any other manufacturing process(es) and thereafter the bonding pads 22 and the retainer wire 24 are secured to one another.

The bonding pads 22 and the retainer wire 24 can be made of any single material or combination of materials that one finds suitable for forming the orthodontic retainer 20. Examples of materials that can be used include, but are not limited to, metal, graphene, carbon, carbon fiber, plastic, and ceramic. In the case of metal, the metal can be any metal suitable for use in dental applications and that provides the requisite durability and strength needed for a fixed orthodontic retainer. Examples of metals that can be used include, but are not limited to, gold, platinum, titanium, and metal alloys such as an alloy primarily composed of cobalt, chromium and molybdenum having the brand name VITALLIUM, or a nickel titanium alloy.

In one embodiment, the retainers described herein can be formed with one or more positive seats that are configured to at least partially wrap around one or more of the teeth. Examples of positive seats include, but are not limited to, ball clasps, C clasps, and the like. The positive seat(s) can be integrally formed with one of the bonding pads 22 and/or with the retainer wire 24, or be formed separately and then secured to the bonding pad 22 and/or the retainer wire 24. The positive seat(s) helps to ensure that the retainer is properly oriented and installed on the patient since the positive seat(s) ensures that the retainer can only be properly oriented in one orientation on the patient.

The following is an example technique of creating the retainer 20 by additive manufacturing, where the retainer 20 is designed for use on the lingual surfaces of four teeth of the lower set of teeth of the patient. To create the retainer 20, a digital scan of relevant portions of the patient's mouth is obtained to create a digital data file. The digital scan can be performed using conventional digital scanning techniques such as performing a scan of an impression of the patient's mouth, or using an intra-oral digital scanner to intraorally scan the patient's mouth. Examples of intra-oral scanners include, but are not limited to, Planmeca's PlanScan, 3Shape's TRIOS, Sirona's Apollo DI and OmniScan, Invisalign's Itero and 3M's True Definition Scanner. The digital data file is then used to generate an image of the patient's teeth. The retainer 20, including the bonding pads 22 and the retainer wire 24, are then electronically designed and an image of the retainer 20 is generated and electronically overlaid in position on the lingual surfaces of the image of the patient's teeth.

Once the design of the retainer 20 is finalized, the digital data file of the retainer 20 is used to control an additive manufacturing machine to form the retainer 20, including the bonding pads 22 and the retainer wire 24, by additive manufacturing. Applicant believes that processing and formatting digital data for use in creating 3D printed products is well known in the art. Further, the digital data file can easily be saved for later re-fabrication of another retainer 20 if necessary. In the embodiment of FIG. 4, it is possible that a single one of the bonding pads 22 or multiple ones of the bonding pads 22 can be formed separately from the retainer wire 24.

Referring to FIG. 7, once the retainer 20 is created, the retainer 20 needs to be secured to the patient's teeth. Assuming the retainer 20 is to be fixed to the lingual surfaces of four teeth of the lower set of teeth of the patient, FIG. 7 is a side cross-sectional view of one tooth showing the bonding pad 22 on the lingual surface of that tooth. To secure the bonding pad 22 to the tooth, a UV curable adhesive 70 can be used. The UV curable adhesive 70 can first be applied to the tooth surface, followed by placing the bonding pad 22 on the tooth over the applied adhesive 70. Alternatively, the UV curable adhesive 70 can be applied to the tooth facing side of the bonding pad 22, and then the bonding pad 22 placed in position onto the lingual surface. Any means or sequence for applying the UV curable adhesive 70 and the bonding pad 22 to the tooth surface can be utilized. Regardless of the sequence used, some of the UV curable adhesive 70 remains between the tooth facing surface (or rear surface) of the bonding pad 22, while some of the UV curable adhesive 70 flows upward through the apertures 54 and possibly onto the front surface of the bonding pad 22. UV radiation from a UV light source (which is known in the art) is then directed onto the bonding pad 22 and the UV curable adhesive 70. The UV radiation cures the radiation curable adhesive 70 thereby adhering the bonding pad 22 to the lingual surface of the tooth.

As described above, the retainer described herein can form a dental bridge where one or more artificial teeth, also referred to as a pontic, can be secured to the retainer, for example to the retainer wire and/or to one of the bonding pads. The artificial tooth fills in a gap between teeth of the patient when the dental bridge is installed. For example, in the example depicted in FIG. 5, tooth 2 could be missing and the retainer 20 can include an artificial tooth, for example fixed to the retainer wire 24, that fills the gap between teeth 1 and 3 when the retainer 20 is installed.

FIG. 8 illustrates another embodiment using some of the structures described herein in the form of a dental bridge 100 secured in place on a set of teeth. Only a portion of the set of teeth is illustrated. The dental bridge 100 can be used on an upper set of teeth or a lower set of teeth. The dental bridge 100 includes a mounting structure 102 and at least one pontic (or artificial tooth) 104 secured to the mounting structure 102. The mounting structure 102 mounts the dental bridge 100 in the patient's mouth near a gap created by one or missing teeth in the upper or lower set of teeth, with the at least one pontic 104 filling the gap.

In the illustrated example, a single pontic 104 is shown as being attached to the mounting structure 102. However, two or more pontics 104 can be mounted to the mounting structure 102. The pontic 104 is shown as replacing a central incisor of the set of teeth. However, the pontic 104 can be configured to replace any other tooth such as a lateral incisor, a cuspid, a bicuspid, or a molar.

Referring to FIGS. 8-10, the mounting structure 102 includes a first bonding pad 106, a second bonding pad 108, a rigid wire 110, and a pontic attachment structure 112. The bonding pads 106, 108 are configured to secure the bridge 100 to the patient's teeth, with the bonding pads 106, 108 secured to surfaces of teeth on either side of a gap formed by one or more missing teeth of the patient. The bonding pads 106, 108 can be secured to lingual surfaces of the teeth (as depicted in FIG. 8) or the bonding pads 106, 108 can be secured to labial or buccal surfaces of the teeth. The wire 110 keeps the bonding pads 106, 108 spaced apart from each other and supports the pontic 104. The pontic attachment structure 112 forms a structure to which the pontic 104 can be fixed to the mounting structure 102.

The bonding pads 106, 108 can have any construction suitable for securing the bonding pads 106, 108 to surfaces of the teeth. For example, the bonding pads 106, 108 can have a construction like the bonding pads 22 described above. The wire 110 can have a construction like the wire 24 described above.

The pontic attachment structure 112 is fixed to the rigid wire 110 between the first bonding pad 106 and the second bonding pad 108. The pontic attachment structure 112 is configured to mount the pontic 104 thereto. The pontic attachment structure 112 can have any construction that is suitable for mounting the pontic thereto. In the illustrated example, the pontic attachment structure 112 comprises a plate or a bonding plate to which the pontic 104 is attached thereto. The plate has a plurality of apertures 114 extending completely therethrough in a thickness direction of the plate. The plate may be curved, for example concavely curved, to generally match the curvature of the patient's anatomy at the location of the missing tooth. The apertures 114 allow an adhesive, such an acrylic adhesive, to flow through the plate for bonding the pontic 104 to the plate. In addition, in the illustrated example, the pontic attachment structure 112 extends forwardly from the rigid wire 110, the rigid wire 110 is attached to a top surface of the pontic attachment structure 112, and the pontic attachment structure 112 is fixed to the rigid wire 110 about halfway along a length of the rigid wire 110. However, other constructions and locations of the pontic attachment structure 112 are possible.

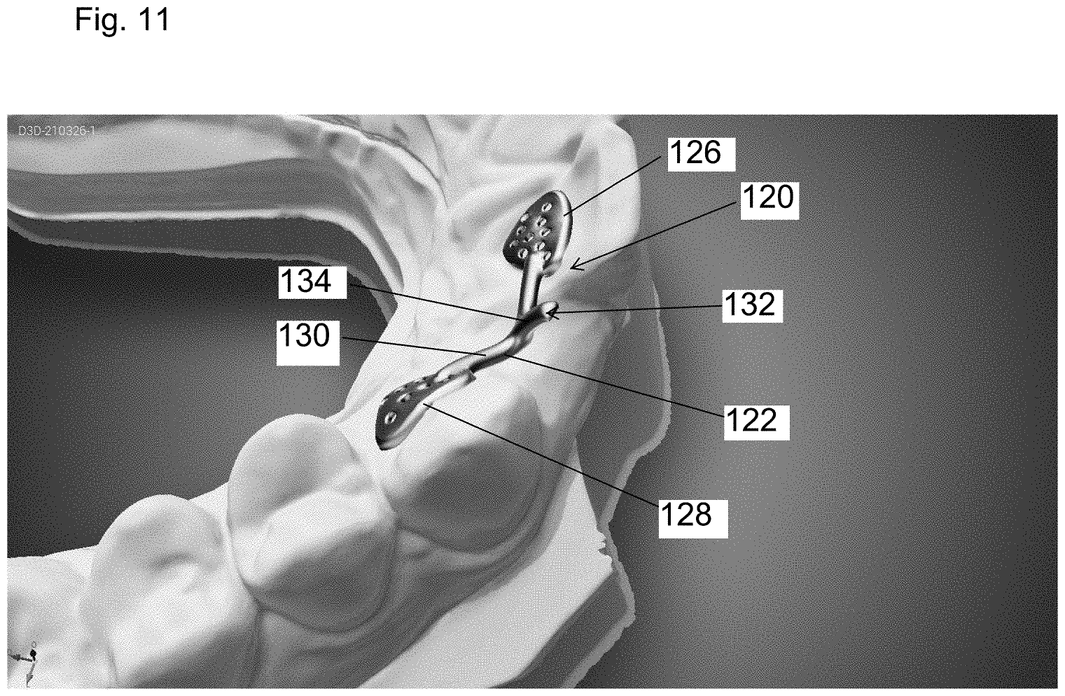

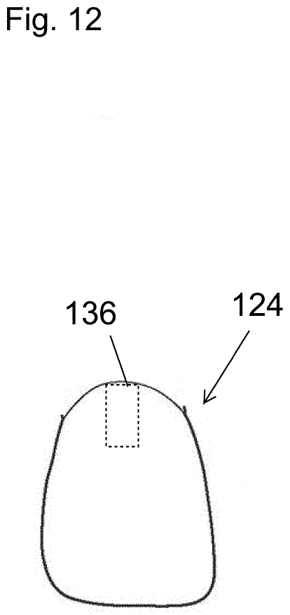

FIGS. 11-12 illustrate another example of a dental bridge 120 that can be used on an upper set of teeth or a lower set of teeth. The dental bridge 120 includes a mounting structure 122 and at least one pontic (or artificial tooth) 124 (shown in FIG. 12) secured to the mounting structure 122. The mounting structure 122 mounts the dental bridge 120 in the patient's mouth near a gap created by one or missing teeth in the upper or lower set of teeth, with the at least one pontic 124 filling the gap.

In the illustrated example, the mounting structure 122 is configured to mount a single pontic 124 thereon. However, two or more pontics 124 can be mounted to the mounting structure 122. The pontic 124 is shown as replacing a central incisor of the set of teeth. However, the pontic 124 can be configured to replace any other tooth such as a lateral incisor, a cuspid, a bicuspid, or a molar.

Referring to FIGS. 11-12, the mounting structure 122 includes a first bonding pad 126, a second bonding pad 128, a rigid wire 130, and a pontic attachment structure 132. The bonding pads 126, 128 are configured to secure the bridge 120 to the patient's teeth, with the bonding pads 126, 128 secured to surfaces of teeth on either side of a gap formed by one or more missing teeth of the patient. The bonding pads 126, 128 can be secured to lingual surfaces of the teeth (as depicted in FIG. 11) or the bonding pads 126, 128 can be secured to labial or buccal surfaces of the teeth. The wire 130 keeps the bonding pads 126, 128 spaced apart from each other and supports the pontic 124. The pontic attachment structure 132 forms a structure to which the pontic 124 can be fixed to the mounting structure 122.

The bonding pads 126, 128 can have any construction suitable for securing the bonding pads 126, 128 to surfaces of the teeth. For example, the bonding pads 126, 128 can have a construction like the bonding pads 22 described above. The wire 130 can have a construction like the wire 24 described above.

The pontic attachment structure 132 is fixed to the rigid wire 130 between the first bonding pad 126 and the second bonding pad 128. The pontic attachment structure 132 is configured to mount the pontic 124 thereto. The pontic attachment structure 132 can have any construction that is suitable for mounting the pontic thereto.

In the illustrated example, the pontic attachment structure 132 comprises a male support post 134 that may be fixed to the rigid wire 130, for example about halfway along a length of the rigid wire 130. However, other configurations are possible. The support post 134 extends upwardly and slight forwardly from the wire 130, although other configurations are possible.

The support post 134 is configured to fit within a female mount 136 (shown in dashed lines in FIG. 12), such as a female recess, formed in a base of the pontic 124 proximate the center thereof for supporting the pontic 124 and attaching the pontic 124 to the mounting structure 122. The support post 134 and the female mount 136 can have any construction that allows the support post 134 to fit within the female mount 136 to mount the pontic 124 to the mounting structure 122. The support post 134 may be circular in cross-section, or have other cross-sectional shapes such as square, rectangular, triangular, oval, and the like. Similarly, the recess forming the female mount 136 can have a shape suitable to receive the support post 134 such as circular, square, rectangular, triangular, oval, and the like. In one embodiment, the shape of the support post 134 and the shape of the recess of the female mount 136 can match one another (for example, if the support post 134 has a circular cross-section, the recess of the female mount 136 may also have a circular cross-section). In another embodiment, the support post 134 may also include external threads that mate with interior threads formed on the female mount 136 for threading the pontic 124 onto the mounting structure 122.

In one embodiment, the mounting structures 102, 122 of FIGS. 8-11 may be formed as a unitary one-piece construction using an additive manufacturing process. Additive manufacturing as used herein is intended to encompass any process where the mounting structures 102, 122 are created by adding layer-upon-layer of material to create the mounting structures 102, 122. Examples of materials that can be used to form the mounting structures 102, 122 include, but are not limited to, metals including but not limited to pure metals such as gold, platinum, or titanium, or metal alloys such as stainless steel, nickel titanium, or a chromium-cobalt alloy; graphene; carbon; carbon fiber; plastic; and ceramic.

The mounting structures 102, 122 may also be formed using other techniques. For example, individual parts of the mounting structures 102, 122, such as the bonding pads, the wire and the pontic attachment structures, can be separately formed, and then the parts can be assembled to form the mounting structures 102, 122. The individual parts can be formed by additive manufacturing, a subtractive manufacturing process, casting or any combination thereof.

The pontics 104, 124 may be formed using any suitable process, and formed from any suitable material. For example, the pontics 104, 124 may be formed by an additive manufacturing process, by a subtractive manufacturing process, or any other method. For example, in one embodiment, the pontics 104, 124 can be formed by a subtractive manufacturing process such as in a milling machine known in the art. One example of a suitable milling machine is commonly known in the industry as a CEREC machine. The pontics 104, 124 may be formed from materials including, but not limited to, a ceramic such as porcelain or zirconia; a metal such as gold, platinum, or titanium, or metal alloys such as stainless steel, nickel titanium, or a chromium-cobalt alloy; resins; and combinations thereof.

In one embodiment, the mounting structures 102, 122 and the pontics 104, 124 are formed separately from one another, and the pontic 104, 124 is attached to the respective mounting structure 102, 122 prior to mounting the respective bridge 100, 120 on the patient's teeth. In another embodiment, the mounting structure 102, 122 can be mounted on the patient's teeth, followed by mounting the pontic 104, 124 on the mounting structure 102, 122.

The pontics 104, 124 can be mounted to the mounting structures 102, 122 using any suitable bonding agent known in the art of dentistry/orthodontics, such as a dental cement. For example, with respect to the mounting structure 122 and the pontic 124, a bonding agent can be added into the recess of the female mount 136 followed by inserting the pontic 124 onto the support post 134. In another embodiment, the pontics 104, 124 and the mounting structures 102, 122 may be mechanically attached to one another, for example using the threads described above, or using a snap fit connection, a bayonet-type connection, or other form of mechanical connection.

In another embodiment, the mounting structure 102, 122 can be mounted in an additive manufacturing machine, for example a 3D printer, and the pontic 104, 124 can be formed on (i.e. printed on) the mounting structure 102, 122, with the bridge 100, 120 then being mounted on the patient's teeth.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A dental bridge, comprising:
a first bonding pad having a plurality of apertures extending completely therethrough;
a second bonding pad spaced from the first bonding pad, the second bonding pad having a plurality of apertures extending completely therethrough;
a rigid wire having a first end and a second end, the first end is fixed to the first bonding pad and the second end is fixed to the second bonding pad; and
an artificial tooth secured to the rigid wire between the first bonding pad and the second bonding pad.

2. The dental bridge of claim 1, further comprising a pontic attachment structure fixed to the rigid wire between the first bonding pad and the second bonding pad, and the artificial tooth is secured to the pontic attachment structure.

3. The dental bridge of claim 2, wherein the first bonding pad, the second bonding pad, the rigid wire, and the pontic attachment structure form a unitary, one-piece construction.

4. The dental bridge of claim 2, wherein the first bonding pad, the second bonding pad, the rigid wire, and the pontic attachment structure are formed of metal.

5. The dental bridge of claim 4, wherein the metal is a chromium-cobalt alloy.

6. The dental bridge of claim 2, wherein the pontic attachment structure comprises a male support post, and the artificial tooth includes a female mount that receives the male support post.

7. A method of forming the dental bridge of claim 1, comprising:
integrally forming the first bonding pad, the second bonding pad, and the rigid wire from metal as a unitary one-piece construction using an additive manufacturing process; and
thereafter attaching the artificial tooth to the rigid wire between the first bonding pad and the second bonding pad.

8. The method of claim 7, further comprising integrally forming a pontic attachment structure with the rigid wire between the first bonding pad and the second bonding pad; and attaching the artificial tooth to the pontic attachment structure.

9. The method of claim 8, comprising forming the first bonding pad, the second bonding pad, the rigid wire, and the pontic attachment structure from metal.

10. The method of claim 9, wherein the metal is a chromium-cobalt alloy.

11. The method of claim 7, comprising forming the pontic attachment structure as a male support post; and prior to attaching the artificial tooth, forming a female mount in a base of the artificial tooth that is sized to receive the male support post.

12. A dental bridge, comprising:
a first bonding pad;
a second bonding pad spaced from the first bonding pad;
a rigid wire having a first end and a second end, the first end is fixed to the first bonding pad and the second end is fixed to the second bonding pad;
a pontic attachment structure fixed to the rigid wire between the first bonding pad and the second bonding pad; and
an artificial tooth secured to the pontic attachment structure.

13. The dental bridge of claim 12, wherein the first bonding pad, the second bonding pad, the rigid wire, and the pontic attachment structure form a unitary, one-piece construction.

14. The dental bridge of claim 12, wherein the first bonding pad, the second bonding pad, the rigid wire, and the pontic attachment structure are formed of metal.

15. The dental bridge of claim 14, wherein the metal is a chromium-cobalt alloy.

16. The dental bridge of claim 12, wherein the pontic attachment structure comprises a male support post, and the artificial tooth includes a female mount that receives the male support post.

17. A method of forming the dental bridge of claim 12, comprising:
integrally forming the first bonding pad, the second bonding pad, the rigid wire, and the pontic attachment structure from metal as a unitary one-piece construction using an additive manufacturing process; and
thereafter attaching the artificial tooth to the pontic attachment structure.

18. The method of claim 17, comprising forming the first bonding pad, the second bonding pad, the rigid wire, and the pontic attachment structure from metal.

19. The method of claim 18, wherein the metal is a chromium-cobalt alloy.

20. The method of claim 17, comprising forming the pontic attachment structure as a male support post; and prior to attaching the artificial tooth, forming a female mount in a base of the artificial tooth that is sized to receive the male support post.
